(19) United States
(12) Patent Application Publication
(10) Pub. No.: US 2006/0256565 A1
(43) Pub. Date: Nov. 16, 2006

(54) Modular lighting device

(76) Inventor: Giuseppe Pugliese, Ladispoli RM (IT)

Correspondence Address: LEFFERT JAY & POLGLAZE, P.A., P.O. BOX 581009, MINNEAPOLIS, MN, 55458-1009, US

(21) Appl. No.: 10/547,982

(22) PCT Filed: Mar. 9, 2004
(86) PCT No.: PCT/IB04/50218

§ 371 Date: Jun. 12, 2006

(30) Foreign Application Priority Data
Mar. 10, 2003 (IT) RM2003A000107

(51) Int. Cl. F21V 15/00; B60Q 3/04

(52) U.S. Cl. 362/362

(57) ABSTRACT

A professional lighting device (1) used on TV and movie sets set, in theatres and the like, having a shell-shaped main body (2) defining thereinside a compartment (3) apt to receive a lamp (4), said main body (2) having a modular structure, comprising at least one top portion (5) and one bottom portion (6) having fixed sizes and interchangeable intermediate components (71, 72, 73, 8) connected to said portions (5, 6), said interchangeable elements (71, 72, 73, 8) being selected so as to obtain an inner compartment (3) having a desired height (FIG. 4).

The present invention refers to a professional lighting device of the type used on TV and movie sets, in theatres and the like.

In the fields of TV and movie shooting, in theater performances and in general during night or daytime shows, there is the need to light up a scene, a person or a detail when light conditions do not suffice to allow a satisfactory viewing or shooting or when specific lighting effects are to be created. In such fields there are commonly used a plurality of lighting devices, differing e.g. in the emitted light power and in the features of the light beam. In particular, in order to obtain such different light beams several kinds of internal lamps, of lenses and/or of fittings having different shape and dimensions are used.

However, the abovementioned known-art lighting devices entail the drawback of requiring an ad hoc designing and manufacturing for each specific lighting demand, i.e. substantially for each lamp power and also for each fitting associated to the lamp itself. Hence, these known lighting devices do not entail any versatility with respect to different applications, thereby being quite uneconomical.

Another drawback of the traditional lighting devices lies In that they merely allow a restricted tilt of the body of the lighting device itself, i.e. of the emitted light beam. This is due to the fact that such known lighting devices have difficulty in disposing of the heat produced by the internal lamp, owing to the substantially vertical arrangement of the latter. In fact, a fraction of the heat developed by such a lamp is transmitted to the structures underlying the lamp, typically the lamp-holder and a sliding fitting-holder, located just at a bottom portion of the external casing of the lighting device. However, when, in order to meet specific stage-related demands as well as lighting ones in general, the lighting device is pivoted about a horizontal axis, the gaps for heat disposal at said structures underlying the lamp are reduced, as, owing to the pivoting, such structures are neared to the support frame of the lighting device and/or to a wall or panel. Therefore, with the increase of the tilt the lamp-generated heat tends to increasingly heat up the lamp base and said structures. Beyond a certain degree of pivoting, their temperature rises to a level such as to damage the plastic elements and to irreparably ruin the lighting device. In general, even in known illuminators providing no plastic elements, the vertical arrangement of the lamp predisposes the latter to overheating, with the entailed life reduction thereof, and induces overheating of the holder and therefore of the electric contacts, risking to blaze the latter and exposing to an excessive temperature the electric cables connected just to the lamp-holder contacts.

A further drawback of the known lighting devices is the low accessibility to the inner compartment housing the lamp. Accordingly, complex maneuvers are required for the servicing of the lighting device.

The technical problem underlying the present invention is to provide a professional lighting device overcoming the drawbacks hereto mentioned with reference to the known art.

This problem is solved by a lighting device according to claim 1 and by a method according to claim 34.

The present invention further refers to a lighting device according to claim 36.

Preferred features of the present invention are set forth in the dependant claims thereof.

The present invention entails several relevant advantages. The main advantage lies in that, by virtue of its modularity, the invention allows the production of an entire range of lighting devices with different lighting power and with different features of the light beam from a single set of common basic components for the various kinds of lighting device. Hence, the same lighting device could be adapted to different applicative demands merely by replacing one or some of its interchangeable components, to the advantage of the versatility and cost-effectiveness of the product.

According to a preferred embodiment, the internal lamp of the lighting device is arranged in a horizontal position, rather than in a vertical one. Such an arrangement allows an improved heat disposal when the lighting device is pivoted about a horizontal axis.

Always according to a preferred embodiment, the lighting device has an openable door for accessing the inner compartment receiving the lamp. This entails the advantage of facilitating servicing to the lighting device Itself.

Other advantages, features and modes of employ of the present invention will be made apparent in the following detailed description of some embodiments thereof, given by way of a non-limiting example. Reference will be made to the figures of the attached drawings, wherein:

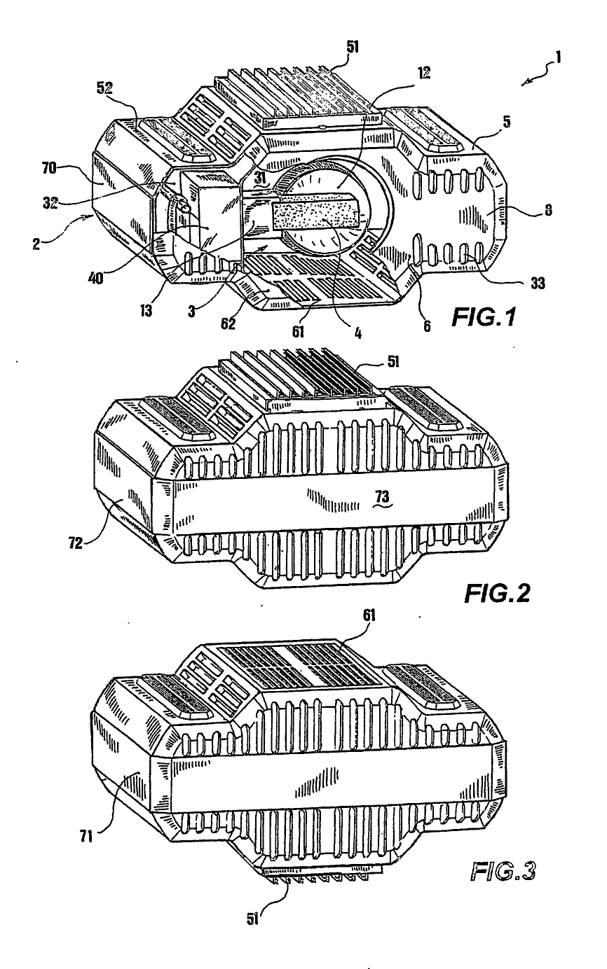

FIG. 1, 2 and 3 show each a perspective view of a first embodiment of the lighting device according to the present invention, taken frontally, rearwardly and rearwardly with the lighting device upturned, respectively;

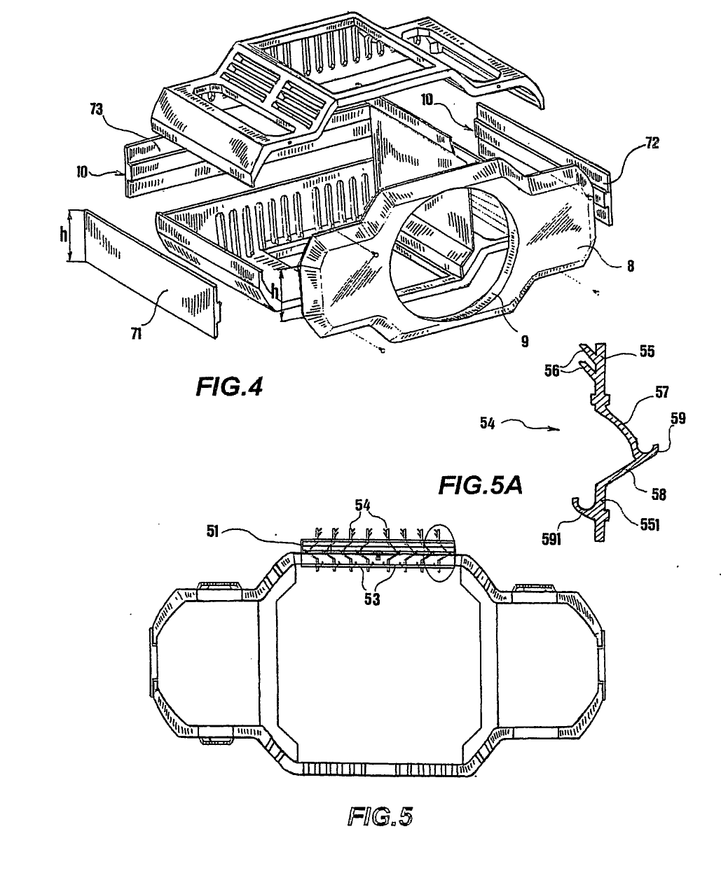

FIG. 4 shows an exploded view of a portion of the outside casing of the lighting device of FIG. 1;

FIG. 5 shows a front sectional view of the lighting device of FIG. 1;

FIG. 5A shows an enlarged detail of FIG. 5;

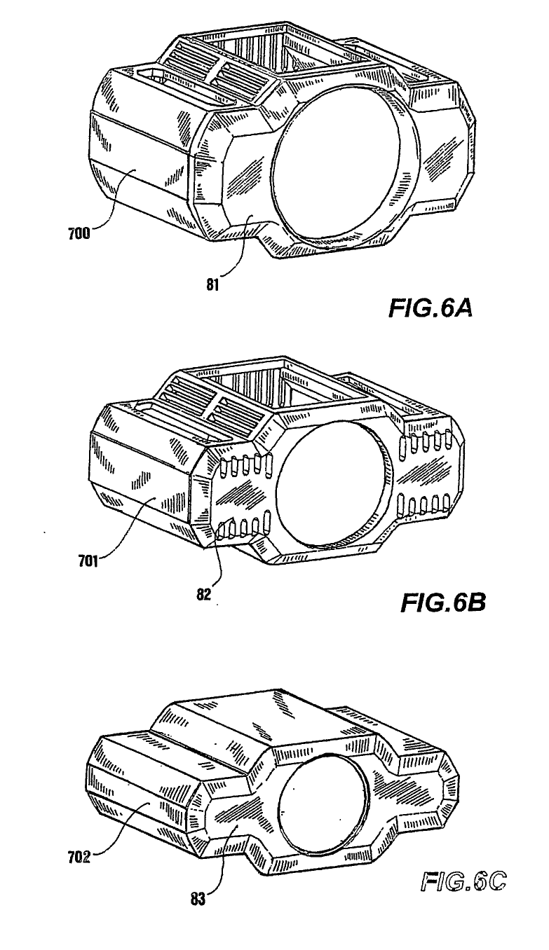

FIGS. 6A, 6B and 6C show each the lighting device of FIG. 1 assembled with differently sized modules;

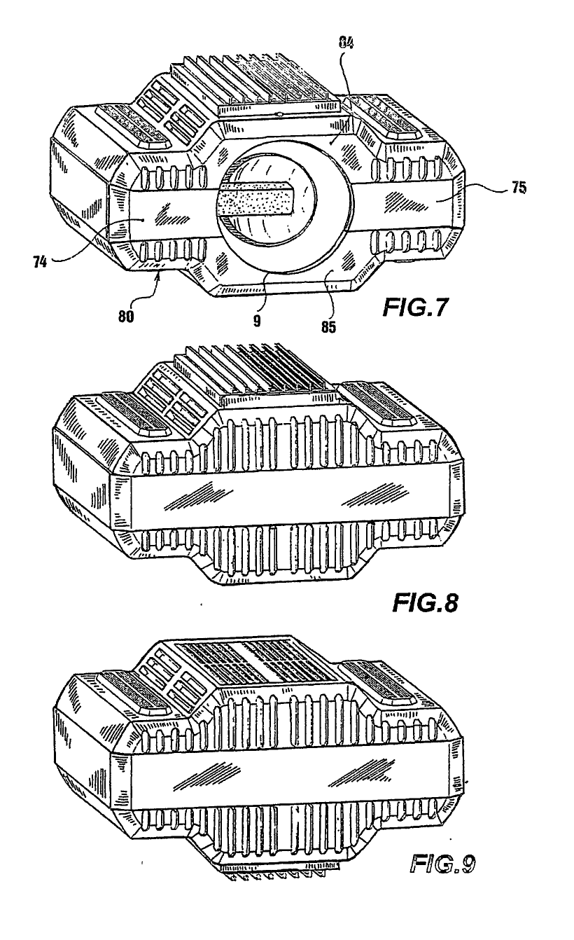

FIGS. 7, 8 and 9 show each a perspective view of a second embodiment of the lighting device according to the present invention, taken frontally, rearwardly and rearwardly with the lighting device upturned, respectively;

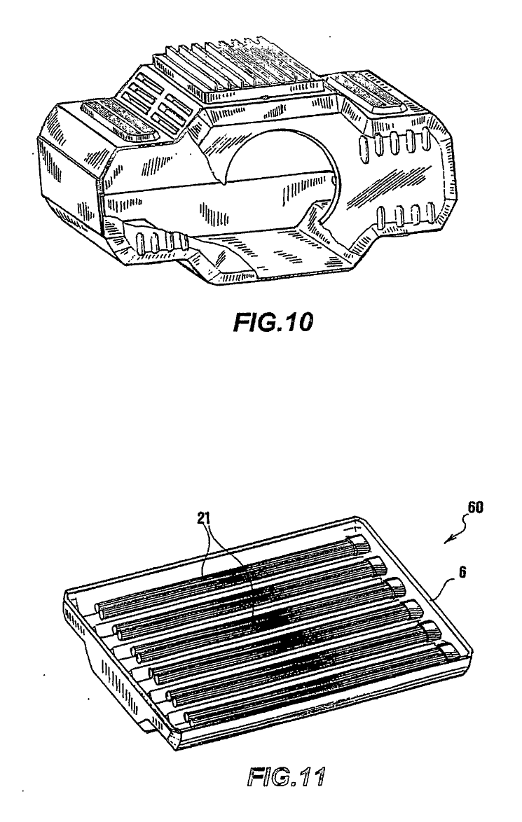

FIGS. 10 and 11 refer to a third embodiment of the lighting device according to the present invention, showing a front perspective view, a rear perspective view and an internal detail thereof, respectively;

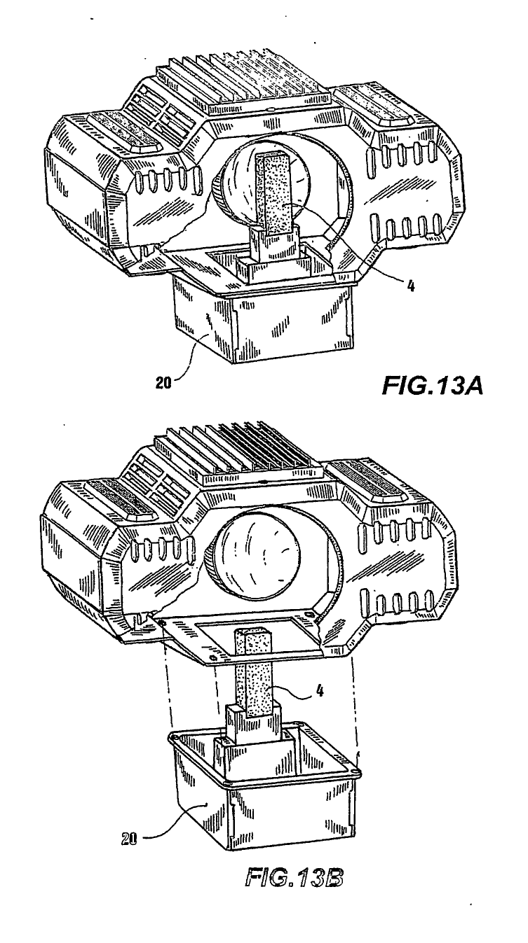

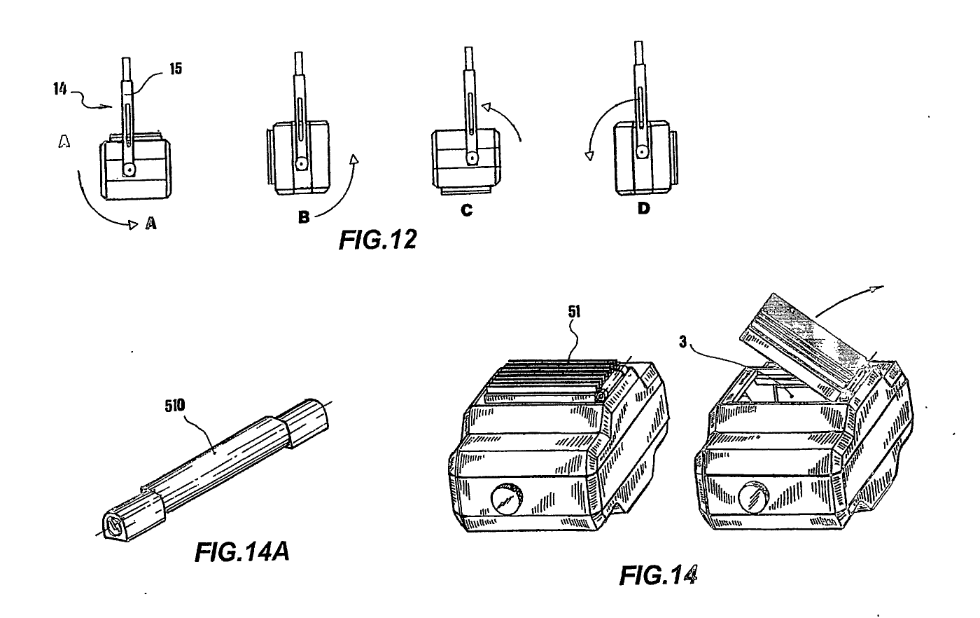

FIGS. 12A to 12D show each a side view of a device for pivoting the lighting device according to the present invention, associable to any embodiment thereof;

FIGS. 13A and 13B show a perspective view and a partially exploded perspective view of a fourth embodiment of the lighting device according to the present invention, respectively, and

FIGS. 14 and 14A refer to a fifth embodiment of the lighting device according to the present invention, showing two general perspective views and a perspective view of a detail thereof, respectively.

With initial reference to FIGS. 1, 2 and 3, a professional modular lighting device according to the invention is generally indicated by 1.

The lighting device 1 comprises a shell-shaped main body 2 defining thereinside a compartment 3 apt to receive a lamp 4 and optional accessory components.

The main body 2 may be made of aluminium or of any other material whatsoever.

In the present embodiment, the main body 2 has an elongate shape and comprises a top portion 5, a bottom portion 6, a front mask 8 and three intermediate side members, the latter arranged adjacently to each other so as to define a side skirt 70 of the body 2 itself interposed between said top 5 and bottom 6 portions.

The top 5 and bottom 6 portions are shaped in a substantially elongate shape and have a plurality of aeration slits. These portions 5 and 6 can also be made of a plurality of components. For example, as it is shown also in FIG. 4, each portion may consist of a peripheral frame 52, 62, receiving a central aeration plate 51, 61. For the sake of simplicity, in the representation of FIG. 4 said plates 51, 61 have been omitted.

Preferably, as In the embodiment of FIGS. 14 and 14A, both or at least one of said plates 51, 61 is removable and/or openable door-like, optionally by means of a hinge 510, so as to allow easy access to the inner compartment 3 of the main body 2.

Of course, variant embodiments can provide the opening up of the casing of the lighting device to take place at a front lens-holding ring, though this solution entails higher costs. In the present embodiment the portions 5 and 6 are symmetrical and interchangeable therebetween.

FIGS. 5 and 5A show in greater detail the top plate 51. As shown in said figures, the plate 51 has a plurality of cooling slits 53, sequentially arranged parallel to each other and delimited by cooling flaps 54.

Each flap 54 Is generally substantially C-shaped. In particular, each flap 54 has a substantially vertically developing first segment 55, onto which there are applied one or more needle-shaped elements 56 (two in the present embodiment) apt to work as light deflectors. Thus, the outletting of light from the compartment 3 other than through a front port 9 is prevented.

Moreover, each flap 54 has a second 57 and a third 58 segment, mutually converging in an arrowhead. At the vertex of said arrowhead the flap 54 provides a first channel 59 for draining condensate, rainwater or any other liquid, arranged so as to prevent such liquids from reaching the lamp 3.

Each flap 54 further comprises a lower segment 551, it also substantially vertically developing, having a second liquid draining channel 591 projecting at the opposite part with respect to the first channel 59.

With reference also to FIG. 4, the main body 2 further comprises said intermediate side elements, and precisely a left intermediate element 71, a right intermediate element 72 and a rear intermediate element 73. The three elements 71, 72 and 73 have the same height H and generally define a substantially C-shaped configuration of said side skirt 70. In particular, such side skirt 70 has a substantially polygonal profile, and the intermediate components 71, 72 and 73 are arranged each at one side of said polygonal profile.

A variant embodiment provides that the skirt 70 be implemented by a single C-shaped band, rather than by three distinct elements.

Said front mask 8, frontally closing the inner compartment 3 of the main body 2, has a conventional lighting port 9 for the passage of the light produced by the lamp 4. As in the known lighting devices, onto the port 9 a lens or the like may be mounted.

The top portion 5 and the bottom portion 6 are connected to the intermediate elements 71, 72 and 73 and to the front mask 8 by reversible fixing means 10, based e.g. on a shape coupling and schematically depicted In the figures.

Preferably, the top 5 and bottom 6 portions are also directly connectable to each other without interposition of the elements 71, 72 and 73.

The overall arrangement is such that the intermediate elements 71, 72 and 73 and the front mask 8 may be replaced by different components connectable to the same portions 5 and 6 by reversible fixing means analogous to the ones disclosed hereto. Hence, evidently the intermediate components 71, 72 and 73 and the mask 8 mentioned hereto and the components replaceable thereby will have respective means for connecting to the standard common components 5 and 6.

The lighting device I is thus prearranged to change the size of its inner compartment 3 by replacing its interchangeable components 71, 72, 73 and 8 with one or more components having different sizes, and in particular in the present embodiment a different height H. Hence, the lighting device 1 has a modular construction allowing the adjusting of its internal capacity to lamps 4 of different sizes, and therefore of different wattages, and in general the receiving of fittings having different shape and size.

Some exemplary viable and different assemblings for the lighting device 1 are shown in FIGS. 6A, 6B and 6C, each figure providing that the intermediate elements 71, 72 and 73 and the mask 8 be replaced by analogous components having a different size. As it is shown in these figures and as mentioned hereto, all of the different lighting device configurations attainable from the lighting device I share the end portions 5 and 6, whereas they provide front masks, in said figures indicated by 81, 82 and 83, respectively, and intermediate elements, generally indicated by 700, 701 and 702, respectively, having different height with respect to the mask 8 and to the elements 71, 72 and 73.

Therefore, it will be appreciated that by using a set of common components and by providing the interchangeability of a limited number of replaceable components only, the latter of easy and cost-effective manufacturing, there can be attained an extreme versatility of the lighting device 1.

Turning again to FIG. 1, the Inner compartment 3 is subdivided into three compartments, and precisely a central compartment 31 and two side compartments indicated by 32 and 33, respectively. The central compartment 31 is the one housing the lamp 4, typically made of a glass bulb, it also indicated by 4, and by an associated socket or support 13, typically made of ceramics. Moreover, such a central compartment 31 houses additional known components, like e.g. a mirror or parabolic lens 12, generally made of metal, placed in front of port 9 and rearwardly to the lamp 4.

The left side compartment 32 houses means 40 for the electrical connection of the lamp 4, or lamp-holder.

Moreover, the side compartments 32 and 33 house additional electrical, mechanical and/or electronic components, them also known, like e.g. ballast, fans, electric motors, actuators, cables, and so on.

Always with reference to FIG. 1, it will be appreciated that in the present embodiment the particular shaping of the main body 2 allows to insert the support 13 into one of the side compartments 32 or 33, thereby allowing to arrange the lamp 3 in a substantially horizontal position, rather than in a vertical one.

The advantages of such a mounting can be better appreciated also with reference to FIGS. 12A to 12D, showing a device 14 for pivoting the lighting device 1. The device 14 comprises a bracket 15 pivotally connected to the side skirt 70 according to an axis of rotation A substantially horizontal and orthogonal to the drawing plane.

By virtue of the horizontal arrangement of the lamp 4, the lighting device 1 may be rotated about the axis A for 360 degrees along the entire circumference, working also upturned, with no risk of compromising the correct disposal of the lamp-generated heat and thereby avoiding all the hereto-mentioned disadvantages associated with a vertical position of the lamp. In fact, with the lamp mounted in a horizontal position, regardless of the tilt of the lighting device the heat disposal is not hindered by the lamp-holder or by any other optional accessory component, thereby avoiding damages due to an excessive temperature. As illustrated in the foregoing, this drawback occurs instead in the known lighting devices providing a substantially vertical arrangement of the lamp.

Moreover, the abovementioned advantage can be attained by giving to the lamp 4 any tilt whatsoever, even on a plane orthogonal to the front mask 8 and parallel to the bottom portion 6. In general, the lamp 4 can be mounted, in order to attain said advantage, so as to extend according to a plane substantially parallel (instead of orthogonal, as in the known lighting devices) to said axis of rotation A. Therefore, the electrical connection means 40 will have an arrangement apt to determine such a mounting of the lamp 4.

It will be understood that the present invention is susceptible of several embodiments and variants alternative to what has been described hereto, some of which are briefly illustrated hereinafter with reference to the sole aspects differentiating them from the embodiment and from the variant embodiments considered hereto.

A second embodiment is shown In FIGS. 7 to 9. In this case, the front mask, here generally indicated by 80, is subdivided into four parts. In particular, it Is obtained by connecting a top frame 84 and a bottom frame 85, both having a fixed size, to two replaceable intermediate frontal elements 74 and 75 arranged at opposite sides of opening 9.

Therefore, in this embodiment the entire intermediate annular band defining the side skirt is interchangeable. Thus, it is not necessary to use different front masks in order to vary the size of the lighting device, but rather it suffices to merely replace said intermediate band formed by the left 71, right 72, rear 73 and front 74, 75 elements. Thus, the steps required for the production of different designs of lighting device, always from a series of common S components, can be further facilitated and made more cost-effective.

The assembling and the connecting of the portions takes place analogously to what has been described in the preceding embodiment.

According to a variant embodiment, the entire side skirt of the main body could be made of a single ring-shaped continuous element, having a front lens-holding port.

A third embodiment is shown in FIGS. 10 and 11. As it is shown in FIG. 11, the bottom portion 6 (or the top portion 5) of a lighting device like the one described with reference to the first embodiment may be used to make a different lighting device 60 providing the use of one or more fluorescent lamps 21.

A fourth embodiment, shown in FIGS. 13A and 13B, provides the option of using a lamp 4 having the conventional vertical arrangement. With reference to these figures, in this case the lighting device comprises a bottom item-holding box 20, optionally slidable, receiving the base of the lamp. Of course, such a bottom box may be provided in the other embodiments of the invention as well.

Furthermore, it will be understood that the lighting device of the invention can provide any known accessory whatsoever, like e.g. systems for moving the lamp, lenses or focusing systems, slits, cooling and aeration systems, lamp driving systems, manual as well as automatic or motor-driven actuators, and so on.

Moreover, the lighting device can receive any kind of lamp, even one different from the hereto-considered ones.

In addition, the connection between the different components, and in particular both between those interchangeable and those having fixed dimensions, can be implemented by fixed connections rather than by reversible ones, e.g. by rivets.

Moreover, it will be understood that the Interchangeable components of the lighting device can also be different from those defining the side skirt of the main body, and comprise e.g. components apt to define the top and/or bottom portions of the lamp. For example, a simplified variant embodiment could provide that the bottom/top portion of the main body be of fixed size and connectable to various top/bottom portions having different sizes.

According to a further embodiment, the main body of the lighting device can provide a front mask 8 as the one described in the first embodiment and an analogous rear mask, each associated with a respective lamp and to a respective mirror lens. In this way, with a single main body two lighting devices are obtained. The two front and rear masks may each be piece-formed or provide a modular construction.

Moreover, the lighting device of the invention may be prearranged to concomitantly or alternatively receive different and differently arranged lamp-holder elements into the same main body. For example, two lamps may be mounted in a horizontal position, the one opposite to the other one, and/or one lamp may be mounted in a vertical position with the aid of a bottom box like that of FIGS. 13A and 13B.

The invention may also be provided in the form of a kit comprising one or more components having a fixed size and one or more interchangeable components. In case the kit comprises a plurality of components or of component sets interchangeable thereamong, it will be suitable for making lighting devices having different sizes.

It will be understood that the invention likewise refers to a method for making a professional lighting device as described in the hereto-considered embodiments, said method providing that such a lighting device be made of one or more components having fixed sizes, like e.g. the top 5 and bottom 6 portions of the first embodiment, and of one or more replaceable components, like e.g. the intermediate elements 71, 72 and 73, that are actually interchangeable with other components having different sizes, said replaceable component or components being selected so as to obtain a desired size for the inner compartment of the lighting device.

The present invention was hereto described with reference to preferred embodiments thereof. It is understood that there may be other embodiments, afferent to the same inventive kernel, all falling within the protective scope of the claims hereinafter.

1. A professional lighting devices of the type used in TV and movie sets, in theatres and the like, having a shell-shaped main body defining thereinside a compartment apt to receive a lamp, which main body has a modular structure, comprising at least one basic components having a fixed size and at least one component interchangeable with other components of a different size, which interchangeable component is connected or connectable to said basic component and selected so as to obtain a desired size for said inner compartment.

2-33. (canceled)

34. A method for making a professional lighting device of the type used in TV and movie sets, in theatres and the like, having a shell-shaped main body defining thereinside a compartment apt to receive a lamp, the method providing that said lighting device be made of one or more components having a fixed size and of components nterchangeable with other components having different sizes, said interchangeable component or components being selected so as to obtain a desired size for said inner compartment.

35. (canceled)

36. A professional lighting device of the type used on TV and movie sets, in theatres and the like, comprising:
a shell-shaped main body having an inner compartments apt to receive a lamp having, at one end thereof, an electric contact said main body being pivotable with respect to an axis of rotation; and
electrical connection means apt to cooperate with the electric contact of the lamp and received in said main body,
wherein said electrical connection means is arranged so as to allow a mounting of the lamp in which the latter extends according to a plane substantially parallel to said axis of rotation.

37-39. (canceled)

40. The lighting device according to claim 1, wherein said shell-shaped main body comprises a first and a second basic component defining end regions of the shell itself and wherein said at least one interchangeable component is an intermediate component, interposed or interposable between said first and second basic components and connected or connectable thereto so as to define a side skirt of said main body.

41. The lighting device according to claim 40, wherein said at least one intermediate component is substantially C-shaped.

42. The lighting device according to claim 40, wherein said at least one intermediate component has a substantially annular shape.

43. The lighting device according to claim 40, wherein said first and second basic components respectively define a top region and a bottom region of said main body.

44. The lighting device according to claim 40, wherein said first and second basic components are also directly connectable to each other..

45. The lighting device according to claim 44, wherein said first and second basic components are removably connectable to each other.

46. The lighting device according to claim 40, wherein said first and second basic components are interchangeable with each other.

47. The lighting device according to claim 1, comprising a plurality of interchangeable components, apt to be arranged adjacently to each other to define a portion of said shell.

48. The lighting device according to claim 47, wherein said plurality of interchangeable components comprises a front mask connected or connectable to the remainder of the main body.

49. The lighting device according to claim 47, wherein said shell-shaped main body comprises a first and a second basic component defining end regions of the shell itself and wherein said at least one interchangeable component is an intermediate component, interposed or interposable between said first and second basic components and connected or connectable thereto so as to define a side skirt of said main body and wherein said main body has, at said side skirt, a substantially polygonal profile, and said plurality of interchangeable components comprises a plurality of intermediate components arranged or apt to be arranged each at one side of said polygonal profile.

50. The lighting device according to claim 1, wherein said interchangeable component or components are removably connected or connectable to the remaining part of said main body.

51. The lighting device according to claim 50, wherein said interchangeable component or components are removably connected or connectable to the remaining part of said main body by reversible fixing means.

52. The lighting device according to claim 1, wherein said at least one interchangeable component has a lens-holding element.

53. The lighting device according to claim 1, wherein said main body has a substantially elongate shape.

54. The lighting device according to claim 53, wherein said main body defines thereinside two side compartments apt to house accessory components of the lighting device itself.

55. The lighting device according to claim 1, wherein said main body has an openable door for allowing access to said inner compartment receiving the lamp.

56. The lighting device according to claim 1, wherein said main body has at least one aeration slits, delimited sideways by at least one flap shaped so as to prevent the outletting of light from the inner compartment of said main body.

57. The lighting device according to claim 56, wherein said flap is substantially C-shaped.

58. The lighting device according to claim 56, wherein said flap has, at an outermost end thereof, at least one light deflector projecting toward said slit.

59. The lighting device according to claim 58, wherein said at least one light deflector is substantially needle-shaped.

60. The lighting device according to claim 56, wherein said flap has at least one projecting element defining a channel for draining liquid, arranged so as to prevent the entry of liquid into an adjacent slit.

61. The lighting device according to claim 1, comprising means for hanging the lighting device itself to a support frame.

62. The lighting device according to claim 61, wherein said main body is pivotally connected to said means for hanging the lighting device to a support frame.

63. The lighting device according to claim 1, wherein said interchangeable component(s) is/are selected so as to obtain a desired height for said inner compartment.

64. The lighting device according to claim 1, comprising electrical connection means, apt to cooperate with an electric contact of the lamp and received in said main body, wherein said main body is pivotable with respect to an axis of rotation and wherein said electrical connection means is arranged so as to allow a mounting of the lamp according to which the latter extends according to a plane substantially parallel to said axis of rotation.

65. The lighting device according to claim 64, wherein said electrical connection means is arranged at a side portion of said main body, so as to allow a tilted non-vertical arrangement of the lamp.

66. The lighting device according to claim 64, wherein said electrical connection means is arranged so as to allow an arrangement of the lamp substantially parallel to said axis of rotation.

67. The lighting device according to claim 64, wherein said electrical connection means is arranged so as to allow a substantially horizontal arrangement of the lamp.

68. The lighting device according to claim 1, comprising a front mask and a rear mask, each having a respective lens-holding element and respective means apt to receive a respective lamp.

69. The lighting device according to claim 1, wherein said main body is prearranged to concomitantly or alternatively receive different lamp-holding elements.

70. The lighting device according to claim 69, wherein said main body is prearranged to receive different and differently arranged lamp holding elements.

71. The lighting device according to claim 1, provided in a kit comprising at least one basic components and a plurality of interchangeable components or of interchangeable component sets connected or connectable to said basic components, wherein said interchangeable components or interchangeable component sets have different sizes so that to each of them there corresponds a desired size for the inner compartment of the main body.

72. The method according to claim 34, which is used to make a lighting device according to claim 1.

73. The lighting device according to claim 36, wherein said electrical connection means is arranged at a side portion of said main body, so as to allow a tilted non-vertical arrangement of the lamp.

74. The lighting device according to claim 36, wherein said electrical connection means is arranged so as to allow an arrangement of the lamp substantially parallel to said axis of rotation.

75. The lighting device according to claim 36, wherein said electrical connection means is arranged so as to allow a substantially horizontal arrangement of the lamp.
